(19) United States
(12) Patent Application Publication
(10) Pub. No.: US 2010/0320816 A1
(43) Pub. Date: Dec. 23, 2010

(54) VEHICLE SEAT WITH LUMBAR SUPPORT

(75) Inventor: Eric Michalak, Northville, MI (US)

Correspondence Address: FOLEY AND LARDNER LLP;SUITE 500, 3000 K STREET NW, WASHINGTON, DC, 20007, US

(73) Assignee: Johnson Controls Technology Company

(21) Appl. No.: 12/518,077

(22) PCT Filed: Dec. 7, 2007
(86) PCT No.: PCT/US2007/025034

§ 371 Date: Aug. 6, 2009

Related U.S. Application Data
(60) Provisional application No. 60/869,278, filed on Dec. 8, 2006.

(51) Int. Cl. B60N 2/427

(52) U.S. Cl. 297/216.12; 297/216.13

(57) ABSTRACT

A vehicle seat including a seat back and a head restraint coupled to the seat back. The seat includes a lumbar support movably coupled to the seat back so that when a force is applied to the seat back by an occupant of the seat moving rearwardly relative to the seat back the lumbar support moves rearwardly and absorbs energy associated with an occupant's rearward movement.

### CROSS-REFERENCE TO RELATED PATENT APPLICATION

The present application claims priority to and the benefit of U.S. Provisional Patent Application No. 60/869,278, filed Dec. 8, 2006. The foregoing application is incorporated by reference herein in its entirety.

### BACKGROUND

The present application relates generally to a vehicle seat having a lumbar support. A lumbar support provides support for the driver's lumbar vertebrae which include the lowermost five vertebra of the human vertebral column. The lumbar vertebrae are frequently subjected to a high degree of downward pressure, a condition which frequently leads to the condition known commonly as lower back pain.

The vehicle seat back, including the lumbar region, interacts with the occupant during a rear end collision involving the occupant's vehicle. In the event of a rearward impact or rear end collision, the occupant is forced against the seat and can experience a very large energy pulse. In such circumstances, there is typically a separation between the seat back and the thoracic, neck, and head regions of the occupant. Depending on the force of the rear impact, this separation can be quickly and violently closed by a following movement of the upper torso, neck, and head of the passenger toward the seatback in an event commonly known as whiplash. The head is typically subjected to a swift rearward translational motion and/or rotation due to inertia. Various devices and systems have been proposed to eliminate neck rotation associated with a rear collision event.

Certain systems have been proposed to absorb energy associated with a rear end collision to reduce the energy pulse to the occupant. U.S. Pat. No. 5,290,089 discloses a recliner arrangement for a vehicle seat that includes an energy absorber positioned between a linear recliner element and a seat backrest unit. U.S. Pat. No. 5,310,030 discloses an energy-absorbing fastened structure for use with a vehicle seat. U.S. Pat. No. 5,836,647 discloses a rear impact energy absorbing damping system. Each of these patents discloses a method of absorbing energy from a vehicle impact.

Active head restraint systems also offer improved protection of the occupant during a rear end collision, but it may still be possible to better absorb and dissipate the energy generated by the force acting on the seat back in the event of a rearward collision, especially at the pelvic and lumbar areas, which are generally remote from the headrest.

### SUMMARY

According to a disclosed embodiment, a seat for an occupant of a vehicle is provided. The seat includes a seat back and a lumbar support connected to the seat back by an energy absorbing mechanism that permits the lumbar support to move rearwardly relative to the seat back due to a force applied by the occupant in the event of a collision involving the vehicle. The lumbar support is configured so that the support is in a normal position prior to the collision and is restored to the normal position by the mechanism when the force applied to the lumbar support by the occupant is removed. According to an alternative embodiment the seat may include an active head restraint.

According to another disclosed embodiment, a vehicle seat including a seat back and head restraint is provided. The seat also includes a lumbar support movably coupled to the seat back so that when a force is applied to the seat back by an occupant of the seat moving rearwardly relative to the seat back the lumbar support moves rearwardly and absorbs energy associated with an occupant's rearward movement and wherein the lumbar support is configured to move forwardly after the rearward force associated with the occupant is removed from the seat back.

In another disclosed embodiment, a vehicle seat including a seat base and seat back is disclosed. The includes a stationary head restraint; and a lumbar support connected to the seat back by a hinge that pivots during a collision to permit movement of the lumbar support and an occupant into the seat back to reduce the distance between the occupant's head and the head restraint to thereby reduce rotation of the occupant's neck.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic side view of a passenger seat during a rear impact.

FIG. 2A is a schematic view of an active head restraint system.

FIG. 2B is a schematic view of an active head restraint system with lumbar support.

FIG. 2C is a schematic view of the lumbar support of FIG. 2B.

FIG. 3A is a schematic side view of an active head restraint system before an impact according to one exemplary embodiment.

FIG. 3B is a schematic side view of an active head restraint system after impact according to one exemplary embodiment.

FIG. 4 is a schematic rear view of a passenger seat with lumbar support according to one exemplary embodiment.

FIG. 5 is a schematic depiction of a four-way lumbar support according to one exemplary embodiment.

FIG. 6 is a schematic depiction of a two-way lumbar support according to one exemplary embodiment.

FIG. 7 is a schematic isometric view of the vehicle seat with lumbar support attached shown in FIG. 4.

FIG. 8 is an isolated view of the lumbar support and energy absorbing mechanism shown in FIG. 7.

FIG. 9 is a schematic isometric view of the lumbar support attached to the vehicle seat of FIG. 4.

FIG. 10 is an isolated view of the lumbar support and energy absorbing mechanism of FIG. 9.

FIG. 11 is a schematic top view of the lumbar support and energy absorbing mechanism of FIG. 10.

FIG. 12 is a block diagram of a vehicle seat assembly with an energy absorbing mechanism and active head restraint.

FIG. 13 is a block diagram of a vehicle seat assembly with an energy absorbing mechanism and lumbar support.

### DETAILED DESCRIPTION

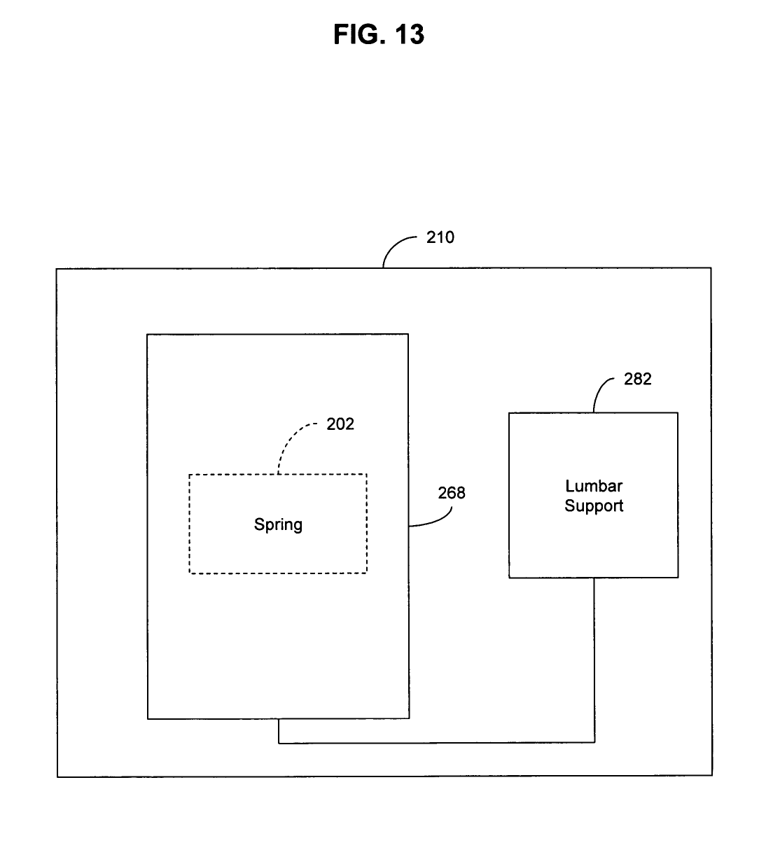

As shown in the figures, a vehicle seat assembly is provided. The vehicle seat 10 may include a seat back 12 and a seat base 14. The seat back may include a seat assembly 210 including a lumbar support 282 connected to the seat back by a energy absorbing mechanism 268. As shown in FIG. 13, according to one embodiment, the energy absorbing mechanism 268 may include a spring 202 for absorbing the force applied by a vehicle occupant against the seat back.

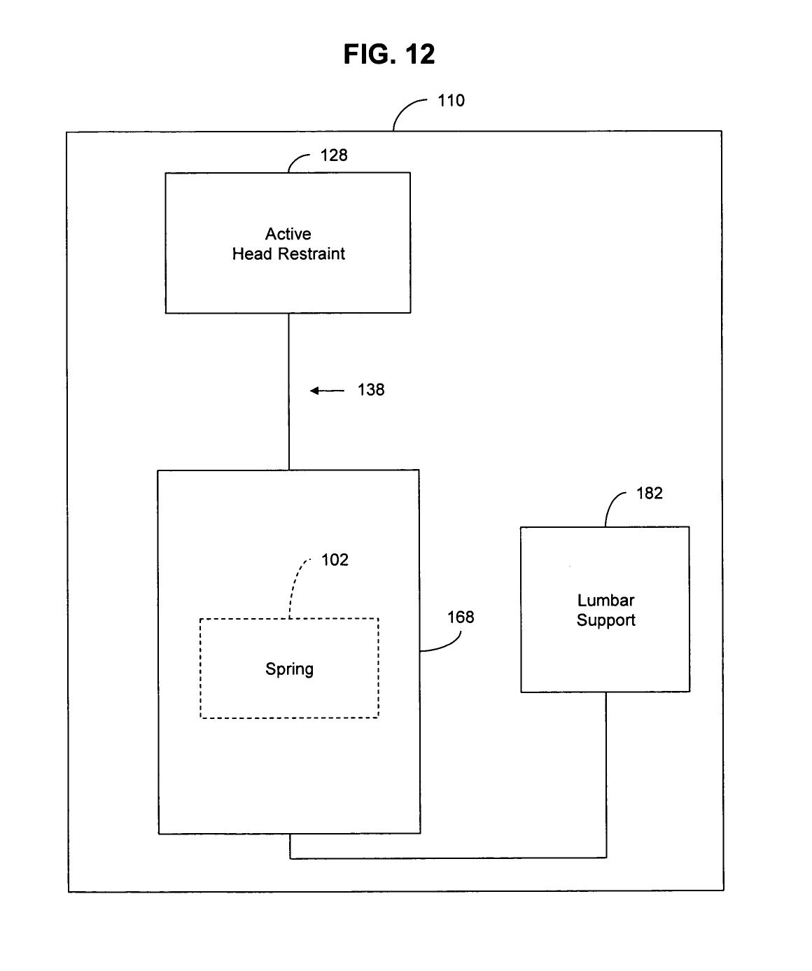

According to another embodiment of a seat assembly 110, shown generally in FIG. 12, the energy absorbing mechanism 168 may be operatively connected (via a cable 138 or other suitable mechanism) to an active head restraint system 128. The spring 102 provides an energy absorbing function and when a predetermined force is applied to the spring 102 the head restraint 128 is actuated.

The spring 102, 202 may preferably be a spiral or coil spring having a resistance or force coefficient permitting the lumbar support 82, 182, 282 to move rearward with respect to the vehicle under predetermined conditions (e.g., the application of force by the occupant O during rearward collision). The spring 102, 202 is one example of an energy absorbing mechanism 68, 168 or 268.

In the illustrated exemplary embodiments of FIGS. 12-13, the energy absorbing mechanism 168, 268 function to allow the lumbar support 182, 282 to “break away” from the seat frame 72 against the biasing force of the spring 102, 202 and dissipate energy as well as (possibly) actuate the head restraint 128. The lumbar support does not detach or actually break free from the seat back or seat frame. Instead, the lumbar support breaks away from its normal position (which may be ON or OFF) and moves rearwardly to absorb energy from the occupant. According to an exemplary embodiment, the lumbar support automatically “resets” or returns to a normal position following removal of the excessive support associated with the rearward collision.

According to one embodiment, the lumbar support may be configured to translate the rearward movement of the lumbar support 182, 282 into a different direction. This translation of movement may be done at a ratio so that small movement of the lumbar support might correspond to a larger movement of an activating cable for a head restraint, for example. It should be appreciated that a number of different mechanisms can be utilized in combination with the spring mechanisms shown in the figures to provide additional energy absorbing, including, but not limited to for example, air bags, hydraulic mechanism, dampers, etc.

As described further below, the lumbar support may have an ON and an OFF position. In the OFF position, the lumbar support is retracted into the seat back. In the ON position, the lumbar support is deployed forward toward the occupant. In the event of a rear end collision, the energy absorbing mechanism is configured to permit rearward movement of the lumbar support into the seat frame or seat back to a position that is rearward of both the ON and OFF position. Thus, the energy absorbing mechanism will function to absorb some of the force of the occupant regardless of whether, at the time of the collision, the lumbar support is ON or OFF. Both the ON and the OFF positions should be considered Normal positions. Preferably, the energy absorbing mechanism (e.g., the spring) is configured to return the lumbar support to the OFF position (i.e., reset the lumbar support) after the collision has occurred and the force is removed from the seat back. However, the energy absorbing mechanism may also be configured to return the lumbar support to the ON position, if desired. Furthermore, the energy absorbing mechanism may be configured to reset the lumbar support while the occupant remains in the seat resting against the seat back or after the occupant is no longer resting against the seat back.

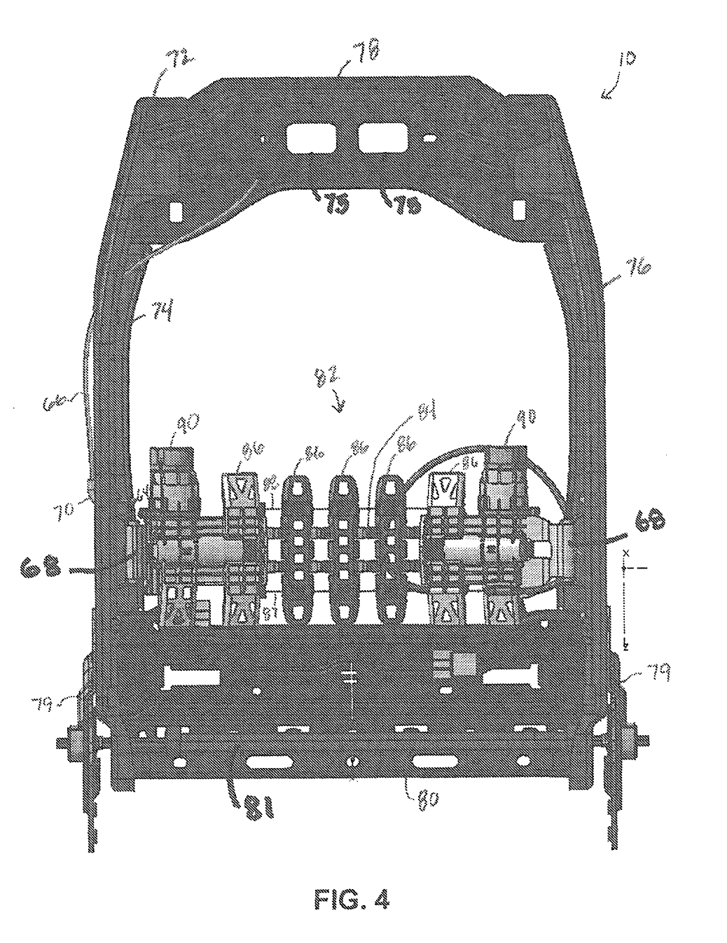

One exemplary embodiment will now be described with reference to the drawings. The seat assembly 10 includes a seat back frame 72, as illustrated in FIG. 4, to structurally support the seat back 12. The seat back frame 72 includes two side members 74 and 76 and two laterally extending members 78 and 80 connecting the side members. Member 78 supports the head restraint 28 and includes two orifices 75 through which the support members 58 may fit. Member 80 supports the lower portion of the seat back frame 72. The seat back frame 72 is secured to the seat bottom 14 through side brackets 79. A recliner rod 81 extends between the two side members 74 and 76 to facilitate the reclining function of the seat 10. The seat back frame 72 may also include other brackets and cross members to support the function of the seat assembly 10.

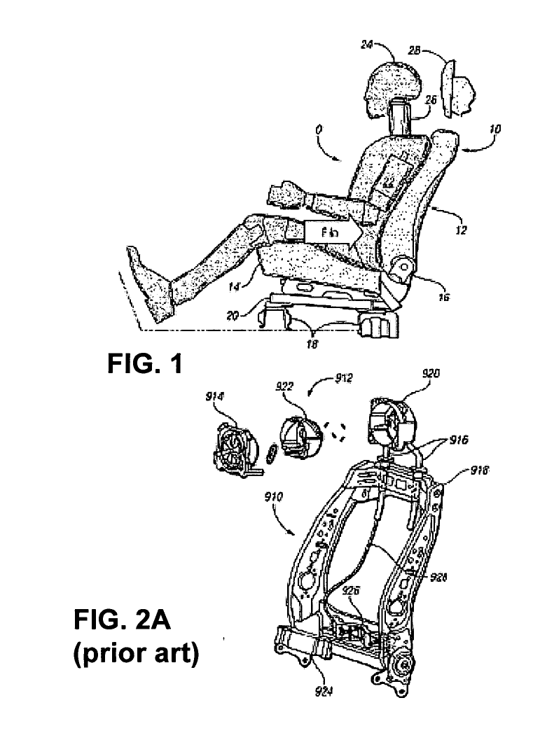

The seat assembly 10 includes a lumbar support 82—for example, a belt-type lumbar support as shown in FIG. 4—which functions to support the midsection 22 of the occupant O as illustrated in FIG. 1. Alternatively, the lumbar support may be a vertical-mounted lumbar support with the track 84 extending vertically as opposed to laterally as shown in lumbar support 82 of FIG. 4. In the illustrated embodiment, each side member 74 and 76 is connected to the lumbar support 82 via an energy absorbing mechanism 68 (shown as a piano hinge).

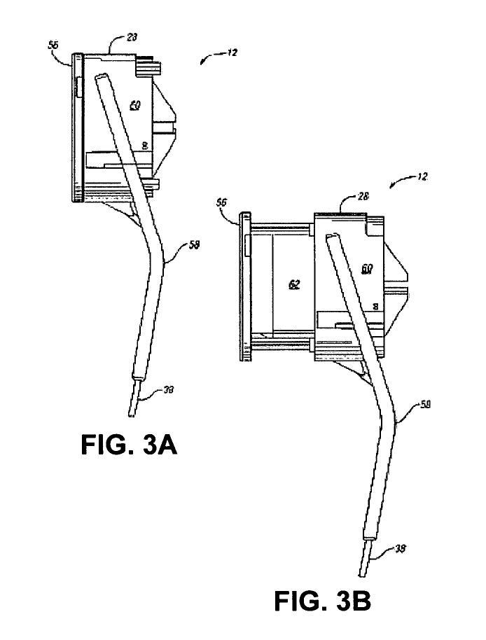

In the embodiment including an optional active head restraint, a connecting link 38 may be provided. The link 38 is attached to the energy absorbing mechanism 68 so that as the mechanism 68 moves with respect to the seat frame 72 the link 38 is moved. The link 38 is connected to an active head restraint 28 (e.g., as shown in FIGS. 3A-B) to actuate the head restraint upon a predetermined amount of displacement of the link 38, energy absorbing mechanism 68 and/or lumbar support 82, with respect to the vehicle seat assembly 10. The lumbar support 82 includes a track 84 that is adjustable with respect to the seat back frame 72. The track 84 includes several vertically extending members 86 interconnected via cables 87, 88.

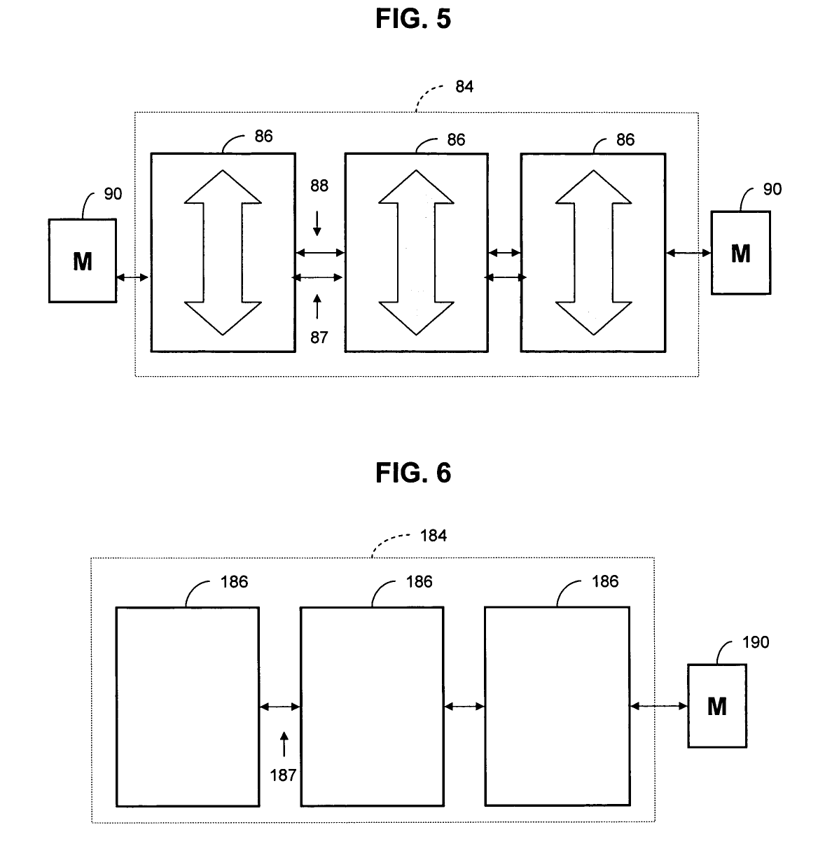

The lumbar support 82, shown in the illustrated exemplary embodiments of FIGS. 4-5, is preferably a four-way adjustable lumbar. The position of the lumbar support 82 and/or track 84 with respect to the vehicle seat assembly 10 is adjustable; the stiffness of the lumbar support 82 and/or track 84 is also adjustable. The lumbar support 82 is attached to two electric motors 90 configured to selectively change the tension in the cables 87, 88 which pass through members 86. Increased tension in the lower support cable 87, for example, increases the overall stiffness of the lumbar track 84 and positions the track at a higher vertical position with respect to the vehicle seat 10. Increased tension in the upper cable 88 also increases the overall stiffness of the lumbar track 84 but positions the track at a lower vertical position with respect to the vehicle seat 10. A simultaneous increase in the stiffness of the upper and lower cables 87 and 88 increases the overall stiffness of the track 84 and also positions the track frontward with respect to the vehicle 18, opposite the force (Fin) shown in FIG. 1. The electric motors 90 enable the occupant O to adjust the position and stiffness of the lumbar support 82 and/or track automatically. Such motors 90 may employ a number of different gearing mechanisms to accomplish this including, for example, spur gears, helical gears, bevel gears, worm gears, rack and pinion gears, planetary gear sets, etc.

As shown in FIG. 6, and as an alternative to the lumbar support 82 of FIGS. 4-5, a lumbar support 182 may be a two-way adjustable lumbar device and include an electric motor 190 attached to a cable 187 of the lumbar track 184. Cable 187 passes through member 186 of the track 184 to selectively change the stiffness of the lumbar support 182 and/or track 184 and the position of the lumbar support 182 and/or track 184 with respect to the vehicle 18. For example, increasing tension in the support cable 187, increases stiffness in the track 184 and positions the lumbar support 182 and/or track 184 frontward with respect to the seat back frame 72 (shown in FIG. 4). Reducing tension in the support cable 187, reduces the stiffness in the track 184 and positions the lumbar support 182 and/or track 184 rearward with respect to the seat back frame 72. In this manner the occupant O may adjust the amount of support provided to the occupant's O lumbar region (or midsection 22) according to occupant preference.

The lumbar supports 82, shown in the illustrated embodiments, are strap or belt-type lumbar supports; however, it should be understood that the lumbar supports 82 may be of any appropriate design. In one exemplary embodiment, the lumbar support components (e.g., 84 and 86) are constructed from a reinforced plastic material, however, in other exemplary embodiments the lumbar support is composed of any appropriate material including metals and or alloys.

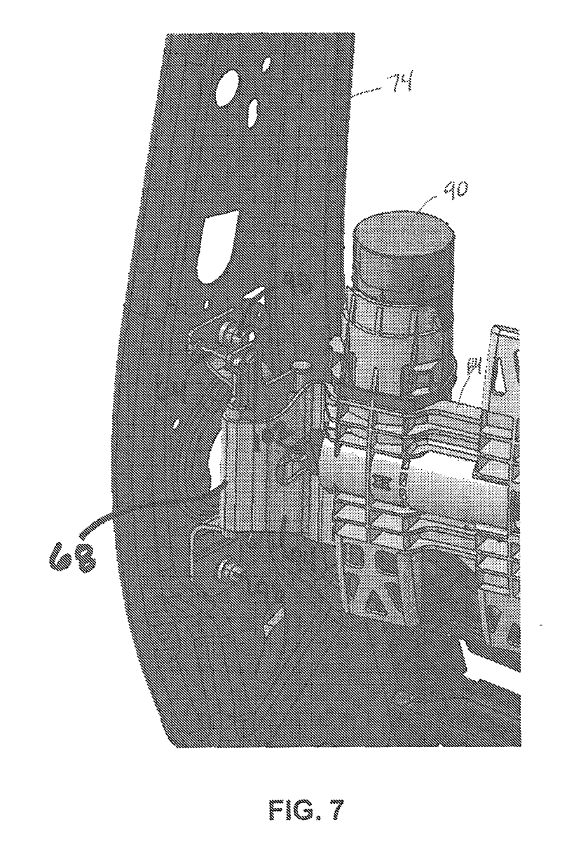

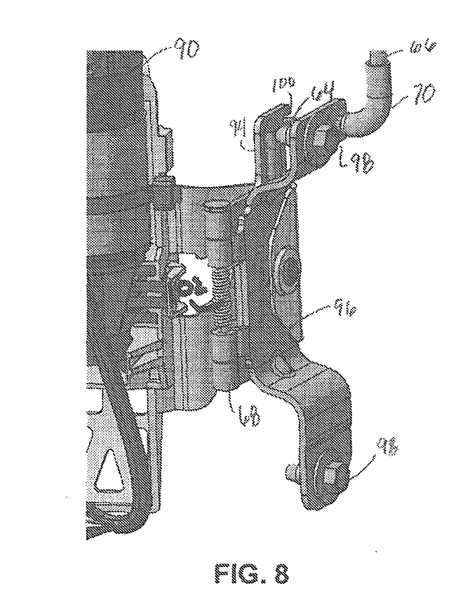

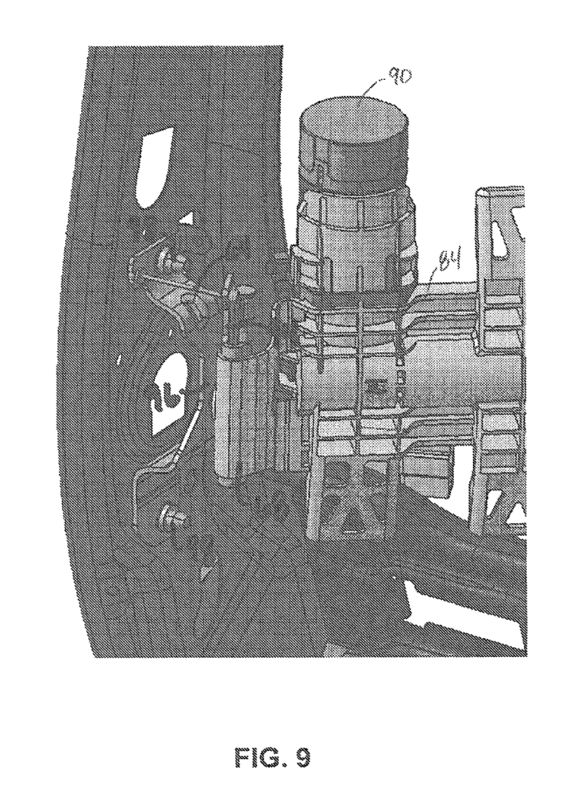

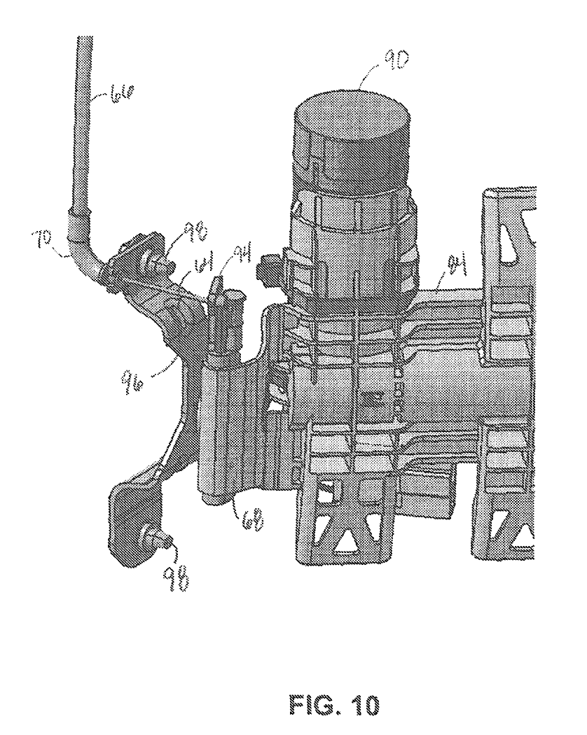

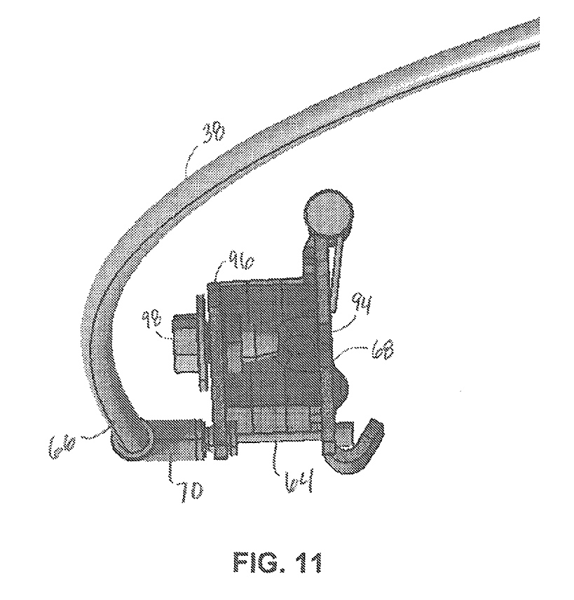

The energy absorbing mechanism 68 connects the lumbar support 82, shown in FIGS. 7-11 to the seat frame 72 and it provides energy dissipation due to a spring (e.g., 102 or other biasing member). In the illustrated embodiments of FIGS. 7-11, the energy absorbing mechanism 68 is similar to a spring biased, door hinge (or piano hinge) which includes two flanges 94 and 96 pivotally connected. Flange 94 is connected to the lumbar support 82 and flange 96 is connected to the side member 74. The flange 94 is secured to the side member 74 via a fastener 98 but may be secured using any appropriate device for securing the flange 94 and the side member 74. The energy absorbing mechanism 68 may include an orifice 100 or hole (as shown in FIG. 8) through which the link 38 passes and is attached to flange 94 of the energy absorbing mechanism 68. As pressure is applied to the lumbar support 82, the two flanges 94 and 96 of the energy absorbing mechanism 68 separate or move overcoming the force of the spring 102 to assume an open position as shown in FIGS. 9-10. In this way the occupant moves into the seat back minimizing the separation between the occupant and the head restraint and thus reducing or eliminating the subsequent neck rotation as the head closes to contact the head restraint. Thus, the disclosed embodiments may eliminate the need for an active head restraint.

The energy absorbing mechanism 68 may be attached to the link 38 as shown in FIGS. 7-12. The link 38 is routed from the head restraint 28 to flange 94 of the energy absorbing mechanism 68. When flanges 94, 96 are moved to the open position (as shown in FIGS. 9-10), the link 38 is displaced with respect to the seat back frame 72. Upon a predetermined amount of displacement of the link 38, the head restraint 28 is deployed toward the occupant O. In this way, the head restraint 28 moves closer to the occupant's O head 24 before substantial strain is placed on the occupants neck 26.

In one embodiment, flanges 94 and 96 may be selectively locked in the closed position (as shown in FIG. 7). At least one of the flanges 94, 96 includes a selectively chargeable magnet (not shown). The magnet is connected to a control unit which sends a signal to a power source which selectively charges the magnet and/or switches the direction or application of current to the magnet. The magnet secures the flanges 94, 96 together upon receiving a predetermined charge or current. In another exemplary embodiment, a solenoid (not shown) is utilized to actuate the movement of flange 94 with respect to flange 96 or a side member 74, 76 to accomplish the same functionality. The lockable feature is not limited to electro-mechanical controls. Any number of latching mechanisms, for example, may be utilized with the present seat assembly 10. The locked or closed position could be considered the ON position for the lumbar support. The OFF position for the lumbar support would allow for some separation between the flanges. In FIG. 10, the flanges are shown in an open position associated with a rear end collision. The relative amount of separation of the flanges can be adjusted according to the particular vehicle platform and desired energy absorbing characteristics.

The spring (e.g., 102 or 202) biases the flanges together or towards a closed position. The spring 102, 202 is a spiral spring and may be set to any stiffness to only allow the lumbar support 82, 182, 282 to move rearward with respect to the vehicle under predetermined conditions (e.g., the application of force by the occupant O during rearward collision).

The vehicle seat may include an active head restraint system for reducing whiplash in a rear or frontal vehicle impact. The active head restraint system includes an active head restraint device that is commonly biased toward a first position, a latch for latching the head restraint device in the first position and an actuator responsive to the movement of a vehicle occupant to release the latch and/or to actuate the active head restraint device. It has been observed that during a rear impact the occupant's body will move rearward with respect the vehicle seat (as shown in FIG. 1). Active head restraint systems have taken advantage of this observation by using the occupant's “body weight” (i.e., the force of the occupant against the seat back of the vehicle seat) to actuate the active head restraint system. The head restraint may operate by the release of a latch which allows the active head restraint to move into a position to better support the occupant's head. The had restraint my be triggered by the rearward force from the occupant's body against the seat back or lumbar support.

The head restraining may be a split active head restraint. The split active head restraint includes a front portion movable with respect to the seat and toward the occupant's head, typically in response to the relative movement of the occupant into the vehicle seat. One system includes a spring-loaded head restraint that translates upward from the seat back. The spring-loaded active head restraint includes a simple latch that is weight-activated to release and deploy the head restraint in a crash.

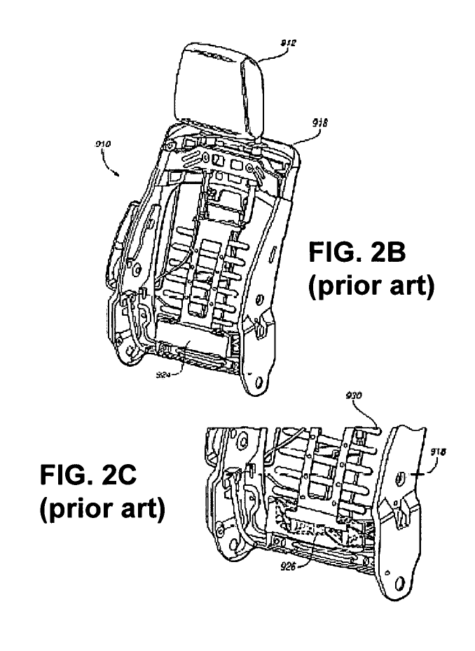

An exemplary active head restraint system 910 is shown in FIGS. 2A-C and 3. The active head restraint system 910 includes a head restraint 912 which enables a front portion 914 of the head restraint 912 to move forward when a force is applied to the back portion of the seat assembly. The active head restraint 912 includes two support members 916 mounted with respect to the head restraint to a frame member 918 of the seat. The head restraint 912 includes a housing 920 that encloses a cam ring 922—the driving member of the active head restraint 912. The cam ring 922 drives the front portion 914 of the head restraint 912 upon actuation. An actuator 924 is located in the bottom portion of the seat back. A set of trusses 926 are coupled to the seat back and connected to a Bowden cable 928. Compression of the trusses 924 with respect to the seat back applies a tensile force to the Bowden cable 928 and actuates the head restraint 912. The head restraint 912 and its operation are more fully disclosed in German Patent Application DE 102 15 137.7, which is incorporated by reference herein.

Referring to FIG. 1, active head restraint systems are utilized to reduce occupant neck injuries during rear impacts. Typically, a vehicle seat assembly 10 includes a seat back 12 and a seat bottom 14. The seat back 12 may be pivotally connected to the seat bottom 14 through a recliner mechanism 16. The seat assembly 10 may be secured to the vehicle 18 through a rail system 20 operative to move the seat forward and rearward with respect to the vehicle 18 or may otherwise be directly attached to a floor of the vehicle 18. In FIG. 1, a manikin representing a vehicle seat occupant ‘O’ is shown positioned in the seat assembly 10 in an upright or design position. During a rear vehicle impact the seat back 12 of the seat assembly 10 is forced against a mid-section 22 of the occupant O such that the occupant O moves rearward relative to (or into) the seat assembly 10 with a force (Fᵢₙ) which has a reactive force from the seat against the mid-section of the occupant. If the force (Fᵢₙ) is substantial enough and the head restraint 28 is not proximate the head 24 of the occupant O, the head 24 may move rearward at a significant rate causing strain to the neck 26 and other body regions of the occupant O. Such an injury is commonly referred to as “whiplash”. Preferably, the head restraint 28 is configured to be actuated to support the head 24 of the occupant O in such instances. The head restraint may be used in addition to (or as an alternative to) the energy absorption mechanism provided with the seat assembly 10 as discussed above. The system operates to reduce the reactive force of the seat against the mid-section 22 of the occupant O during rear impact.

Referring to FIGS. 3A-B, an active head restraint system 30 for an automobile seat assembly 10 is shown. As best illustrated in FIGS. 3A-B, the seat assembly 10 includes an active head restraint system 30 which provides a head restraint 28 that enables a front portion 56 of the head restraint 28 to move toward the occupant's head 24 (i.e., generally opposite Fᵢₙ), shown in FIG. 1, when a force is applied to the seat back 12 of the seat assembly 10. The active head restraint system 30 includes two support members 58 coupled to the head restraint 28 and secured in a sliding relationship with respect to the seat frame 32. The head restraint 28 includes a housing 60 that encloses a cam ring 62, which drives the front portion 56 of the head restraint 28 toward the occupant's head 24 upon actuation. In one exemplary embodiment, a cable or link 38 is provided to actuate the active head restraint system 30 upon movement of the occupant O. It should be appreciated that the active head restraint system 30 may be deployable in a number of manners known within the art. For example, as disclosed in PCT Application No. PCT/US2006/034223 (“Active Head Restraint System”), which is incorporated by reference herein, the head restraint 28 may be included with a system of linkages which actuate the head restraint to move forward with respect to the vehicle seat.

In the illustrated embodiment of FIGS. 3A-B, the head restraint 28 is responsive to movement of a cable or link 38. The link 38 is coupled to the head restraint 28 and an actuator 68 (which may also function as an energy absorbing mechanism). In one exemplary embodiment, the link 38 is a flexible, relatively inextensible cable having an inner portion 64 that is movable with respect to an outer portion 66, as best shown in FIGS. 7-11, an arrangement commonly referred to as a “Bowden” cable. The inner portion 64 is coupled to the actuator 68. The inner portion 64 is guided through the outer portion 66 which includes a curved or bent member 70, as shown in FIGS. 4, 8 and 10-11, to route the link 38 from the seat back 12, through the side member 74 and the up the seat back 12 to the head restraint 28. Accordingly, the curved member 70 is attached to side member 74 in a hole (not shown). It should be appreciated that the link 38 may be any mechanical or electro-mechanical link known within the art. For example, as disclosed in PCT Application No. PCT/US2006/034223, the link 38 may be a rigid member extending through the seat back to the head restraint to actuate the head restraint forward in a rear crash situation.

The construction and arrangement of the elements of the lumbar support 82, 182, 282 for vehicle seat 10, 110, 210 as shown in the preferred and other exemplary embodiments is illustrative only. Although only a few embodiments of the present vehicle seat 10 have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, orientations, etc.) without materially departing from the novel teachings and advantages of the subject matter recited in this disclosure. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present application.

It is important to note that the construction and arrangement of the elements of the lumbar support 82 for vehicle seat 10 as shown in the preferred and other exemplary embodiments is illustrative only. Although only a few embodiments of the present vehicle seat 10 have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, orientations, etc.) without materially departing from the novel teachings and advantages of the subject matter recited in this disclosure. For example, the system for detecting an occupant and determining the weight of the occupant may be used to detect any object or article that may be seated in the vehicle seat. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present application.

What is claimed is:

1. A seat for an occupant of a vehicle comprising:
a seat back;
a lumbar support connected to the seat back by an energy absorbing mechanism that permits the lumbar support to move rearwardly relative to the seat back due to a force applied by the occupant in the event of a collision involving the vehicle;
wherein the lumbar support is in a normal position prior to the collision and wherein the mechanism is configured to restore the lumbar support to the normal position when the force applied by the occupant during the collision is removed.

2. The seat of claim 1 further comprising a head restraint coupled to the seat back.

3. The seat of claim 2 wherein the head restraint includes a deployable portion configured to more forwardly relative to the seat back.

4. The seat of claim 3 wherein the deployable portion is linked to the lumbar support and is actuated by rearward movement of the lumbar support.

5. The seat of claim 4 wherein the deployable portion is linked to the lumbar support by a cable.

6. The seat of claim 1 wherein the energy absorbing mechanism includes a spring, wherein the spring force resists the force against the lumbar support resulting from the occupant moving rearwardly relative to the seat back.

7. The seat of claim 1 wherein the energy absorbing mechanism includes a spring biased pivoting hinge.

8. The seat of claim 7 further comprising a second spring biased pivoting hinge, wherein each hinge connects one end of the lumbar support to the seat back.

9. The seat of claim 1 wherein the lumbar support includes a belt type support extending horizontally across the seat back.

10. The seat of claim 9 wherein the belt type support is connected to the seat back by the energy absorbing mechanism which includes a pair of spring biased pivoting hinges, wherein each hinge is located at an end of the belt type support.

11. The seat of claim 10 wherein each hinge is biased against rearward movement of the lumbar support.

12. A vehicle seat comprising:
a seat back;
a head restraint coupled to the seat back;
a lumbar support movably coupled to the seat back so that when a force is applied to the seat back by an occupant of the seat moving rearwardly relative to the seat back the lumbar support moves rearwardly and absorbs energy associated with an occupant's rearward movement and wherein the lumbar support is configured to move forwardly after the rearward force associated with the occupant is removed from the seat back.

13. The seat of claim 12 wherein the head restraint includes a deployable portion configured to more forwardly relative to the seat back.

14. The seat of claim 13 wherein the deployable portion is linked to the lumbar support and is actuated by rearward movement of the lumbar support.

15. The seat of claim 14 wherein the deployable portion is linked to the lumbar support by a cable.

16. The seat of claim 12 wherein the lumbar support is a belt type support coupled to the seat back by a spring biased pivoting hinge.

17. A vehicle seat comprising:
a seat base and a seat back;
a stationary head restraint; and
a lumbar support connected to the seat back by a hinge that pivots during a collision to permit movement of the lumbar support and an occupant into the seat back to reduce the distance between the occupant's head and the head restraint to thereby reduce rotation of the occupant's neck.

18. The seat of claim 17 wherein the hinge is biased by a spring to resist movement of the occupant into the seat and thereby absorb energy.

19. The seat of claim 17 wherein the lumbar support is a belt type support extending horizontally across the seat back.

20. The seat of claim 19 further comprising a second hinge, wherein the first mentioned hinge connects one end of the lumbar support to the seat back and the second hinge connects another end of the lumbar support to the seat back.
